(19) United States
(12) Patent Application Publication
(10) Pub. No.: US 2011/0025718 A1
(43) Pub. Date: Feb. 3, 2011

(54) INFORMATION INPUT DEVICE AND INFORMATION INPUT METHOD

(75) Inventor: Tomotaka Takarabe, Sapporo-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/846,130

(22) Filed: Jul. 29, 2010

(30) Foreign Application Priority Data
Jul. 30, 2009 (JP) 2009-177433

(51) Int. Cl. G09G 5/00; G06F 3/041

(52) U.S. Cl. 345/661; 345/173

(57) ABSTRACT

An information input device, which displays button images showing a plurality of buttons on a display unit, detects an indication position by a position coordinate detection unit installed in the display unit, and thereby inputs information corresponding to the button which is indicated, includes, an enlargement display unit configured to generate a first enlargement image, which includes an indicated first button among the plurality of buttons, where the vicinity of the first button is enlarged as a display region, and to display the generated first enlargement image on the display unit; a determination unit configured to determine whether an indication region which is indicated in the first enlargement image is included in a first region which is movable in the first enlargement image, or in a second region which instructs the changing of the display region.

### BACKGROUND

1. Technical Field

The present invention relates to an information input device and an information input method.

2. Related art

A touch panel has been used as an input device in various kinds of input processing devices, whereby the touch panel performs processing related to a button displayed at a touched position by the touching of a display screen with a finger. In recent years, along with the functions of the information processing devices becoming more diversified and complicated, when various settings are performed on a single screen, the respective buttons displayed on the touch panel are reduced in size and gaps between the adjacent buttons are decreased, whereby pressing of the wrong button by a user frequently occurs.

In order to prevent the pressing of the wrong button, as disclosed in JP-A-2008-65504 which is an example of a related art, a touch panel control device is proposed which displays an enlargement of selectable buttons which are positioned in the vicinity of a button pressed by a user.

### SUMMARY

However, in the above information processing device, while surrounding buttons included in a predetermined range from the pressed button are enlarged and displayed, other buttons excluded from the display range are not displayed and thus cannot be selected.

An advantage of some aspects of the invention can be realized by the following embodiment or applications.

### Application 1

An information input device according to this application of the invention, which displays button images showing a plurality of buttons on a display unit, detects an indication position by a position coordinate detection unit installed in the display unit, and thereby inputs information corresponding to the button which is indicated, includes, an enlargement display unit configured to generate a first enlargement image, which includes an indicated first button among the plurality of buttons, where the vicinity of the first button is enlarged as a display region, and to display the generated first enlargement image on the display unit; a determination unit configured to determine whether an indication region which is indicated in the first enlargement image is included in a first region which is movable in the first enlargement image, or in a second region which instructs the changing of the display region; a decision unit configured to decide a movement direction of the display region based on a position of the indication region included in the second region; and an input processing unit configured to input information based on the button where an indication for the indication region has been terminated, wherein the enlargement display unit generates a second enlargement image where the display region is moved in a movement direction decided by the decision unit, when the determination unit determines the indication region is included in the second region, and displays the generated second enlargement image on the display unit.

According to this configuration, the information input device generates the first enlargement image, which includes an indicated first button in the button images displayed on the display unit, where the vicinity of the first button is enlarged as a display region, and displays the generated first enlargement image on the display unit.

Here, when the indication region is terminated, the information input device determines that information corresponding to the button according to the indication region has been input, and performs the associated processing. On the other hand, when it is determined that the indication region is included in the second region which instructs the changing of the display region, it generates the second enlargement image where the display region is moved in a movement direction decided based on a position where the indication region included in the second region is positioned in the second region, and displays the generated second enlargement image on the display unit. Therefore, when a button desired by a user is not included in the first enlargement image where the vicinity of one button image indicated by the user is enlarged, in order to display the second enlargement image where the display region is moved in a movement direction based on a position indicated by the user indicating the second region, the user enables the enlargement image including the desired button to be displayed on the display unit by properly indicating the second region. Consequently, the user can select the desired button by indicating and releasing the desired button, and can input information based on the desired button.

### Application 2

In the information input device according to the above application, it is preferable that the decision unit decides the movement direction, based on either a direction from a central position of the first enlargement image to a position of the indication region, a direction from a position where the first button is indicated to a position of the indication region, or a direction predefined according to a position of the indication region.

According to this configuration, the movement direction of the display region can be decided by a direction desired by a user.

### Application 3

In the information input device according to the above application, when the indication of the indication region is terminated, the enlargement display unit preferably continues to display the first enlargement image or the second enlargement image displayed on the display unit so that an indication or an indication termination is possible, and when there is no indication or indication termination for a predetermined time, it preferably displays the button image on the display unit.

According to this configuration, information can be continuously input in the first enlargement image or in the second enlargement image, and further, when information is not input for a predetermined time, the display can be returned to the button image.

### Application 4

In the information input device according to the above application, the enlargement display unit may display a region indicating the first button in the button images so that the region is constituted by the indication region indicating a central portion of the first button in the first enlargement image.

### Application 5

An information input method according to this application of the invention, which displays button images showing a plurality of buttons on a display unit, detects an indication position by a position coordinate detection unit installed in the display unit, and thereby inputs information corresponding to the button which is indicated, includes generating a first enlargement image, which includes an indicated first button in the plurality of buttons, where the vicinity of the first button is enlarged as a display region, and to display the generated first enlargement image on the display unit; determining whether an indication region which is indicated in the first enlargement image is included in a first region which is movable in the first enlargement image, or in a second region which instructs the changing of the display region; deciding a movement direction of the display region based on a position of the indication region included in the second region; generating a second enlargement image where the display region is moved in a movement direction decided at the deciding step, when it is determined that the indication region is included in the second region at the determining step, and displaying the generated second enlargement image on the display unit; and inputting information based on the button where an indication for the indication region has been terminated.

According to this method, the information input method generates the first enlargement image, which includes an indicated first button in the button images displayed on the display unit, where the vicinity of the first button is enlarged as a display region, and displays the generated first enlargement image on the display unit. Here, when the indication region is terminated, the information input method determines that information corresponding to the button according to the indication region has been input, and performs the associated processing. On the other hand, when it is determined that the indication region is included in the second region which instructs the changing of the display region, it generates the second enlargement image where the display region is moved in a movement direction decided based on a position where the indication region included in the second region is positioned in the second region, and displays the generated second enlargement image on the display unit. Therefore, when a button desired by a user is not included in the first enlargement image where the vicinity of one button image indicated by the user is enlarged, in order to display the second enlargement image where the display region is moved in a movement direction based on a position indicated by the user indicating the second region, the user enables the enlargement image including the desired button to be displayed on the display unit by properly indicating the second region. Consequently, the user can select the desired button by indicating and releasing the desired button, and can input information based on the desired button.

### BRIEF DESCRIPTION OF THE DRAWINGS

FIG. 1 is a block diagram illustrating a functional configuration of an information input device according to an embodiment of the invention.

FIG. 2 is a diagram illustrating a hardware configuration of the information input device according to the embodiment of the invention.

FIG. 3 is a diagram illustrating a structure of a touch panel input device.

FIG. 4 is a diagram illustrating an initial screen.

FIGS. 5A, 5B and 5C are diagrams illustrating a shift of an enlargement key input screen which accompanies a movement of a touch region.

FIG. 6 is a flowchart illustrating a flow of processing in the information input device according to the embodiment of the invention.

### DESCRIPTION OF EXEMPLARY EMBODIMENTS

An information input device will now be described with reference to the drawings.

### Embodiment

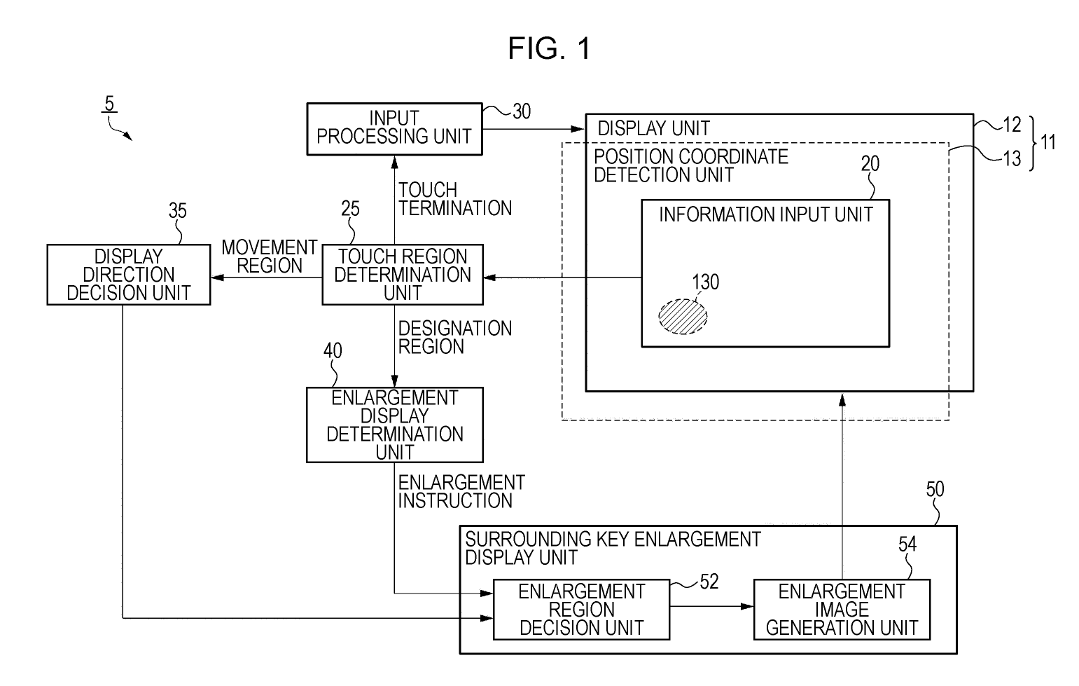

FIG. 1 is a block diagram illustrating a functional configuration of an information input device 5. This information input device 5 includes a display unit 12, a position coordinate detection unit 13, an information input unit 20, a touch region determination unit 25, an input processing unit 30, a display direction decision unit 35, an enlargement display determination unit 40, and a surrounding key enlargement display unit 50. In addition, the surrounding key enlargement display unit 50 has an enlargement region decision unit 52 and an enlargement image generation unit 54. The display unit 12 and the position coordinate detection unit 13 constitute a touch panel input device 11. Each function of the functional units is implemented by cooperation of software and hardware described later. In this embodiment, the information input device 5 is installed in an operation panel of an information processing device such as a printer, a copier, a facsimile device, an automated teller machine (ATM), a portable digital assistance (PDA), and so forth, and provides a user with an interface function where the user indicates by pressing (touching) with a finger and thereby the indication is input corresponding to the touch position.

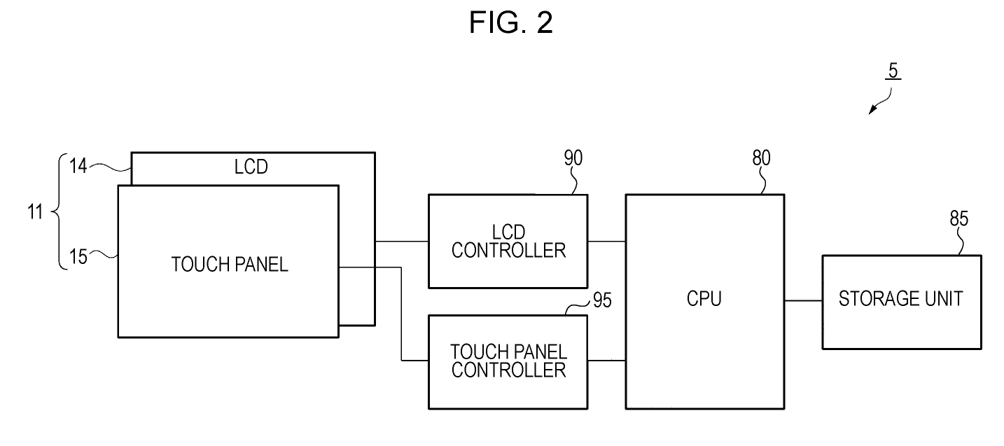

FIG. 2 is a diagram illustrating a hardware configuration of the information input device 5.

Hardware for the information input device 5 includes a CPU (Central Processing Unit) 80, a storage unit 85, an LCD controller 90, a touch panel controller 95, and the touch panel input device 11 having a touch panel 15 and an LCD (Liquid Crystal Display) 14.

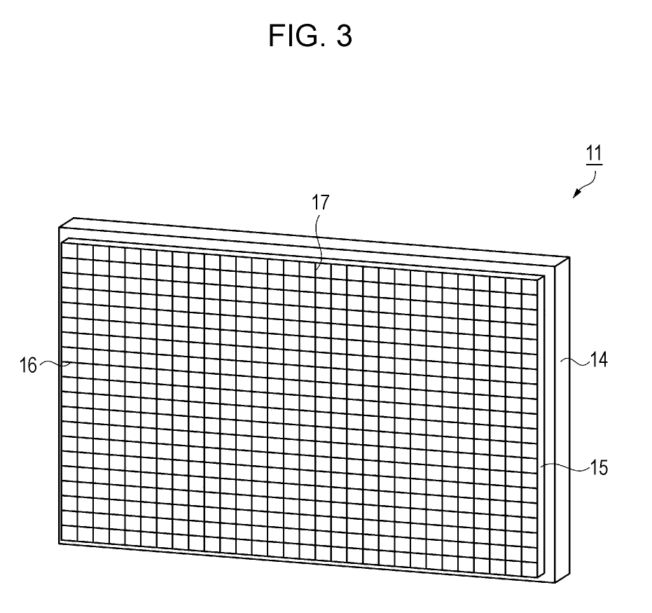

FIG. 3 is a diagram illustrating a structure of the touch panel input device 11. As is commonly known, the touch panel 15, which has a predetermined position relation and is transparent, is disposed on a surface of the LCD 14 which displays images. On a surface of the touch panel 15, a plurality of X-axis electrode lines 16 are provided in parallel in the transverse direction, and a plurality of Y-axis electrode lines 17 are provided in parallel in the longitudinal direction. In the X-axis electrode lines 16 and the Y-axis electrode lines 17, a drop in voltage is generated by a touch of a finger, and which position in the touch panel 15 is touched by the finger is detected based on the positions of the X-axis electrode lines 16 and the Y-axis electrode lines 17 where the drop in voltage is generated. For example, when a drop in voltage is generated at three X-axis electrode lines 16 and Y-axis electrode lines 17, an intersecting point of the electrode lines in each central portion is designated as a touch position.

The touch panel in this embodiment is an example of the position coordinate detection unit 13, and is not limited to the above-described matrix switch type, but it may adopt various types including a resistive type, a surface elastic wave type, an infrared type, an electromagnetically induced wave type, a capacitive type and the like. In addition, the indication method is not limited a finger, but indication may also be made using a stylus pen.

As described above, the information input device 5 is a device for a user to input information via the touch panel 15. In this embodiment, the LCD controller 90 displays the user interface screen (UI screen) of the information input unit 20 and the like on the LCD 14, depending on commands of the CPU 80. The LCD 14 is an example of the display unit 12, and there are no limitations to a display type or a display medium.

Also, a user touches a desired region in the UI screen displayed on the LCD 14 with a finger, and the touch panel controller 95 thereby calculates a coordinate of the touch position on the surface of the touch panel 15. The calculated position coordinate is input to the CPU 80, and the CPU 80 executes a function corresponding to the position coordinate.

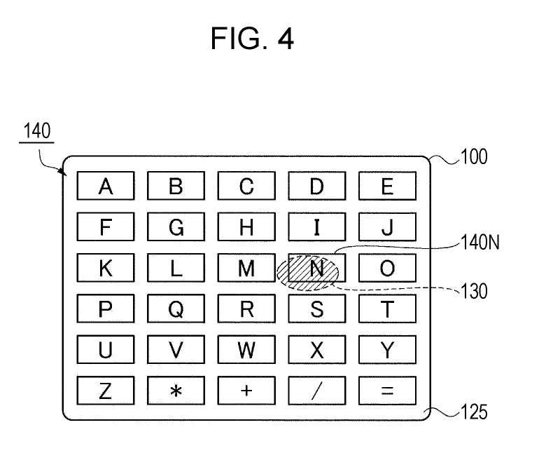

The functional units of the information input device 5 will be described in detail with reference to FIG. 1. The information input unit 20 is an input unit for a user to input information, and, in this embodiment, an initial key input screen 100 as shown in FIG. 4 is initially displayed on the display region of the touch panel input device 11. A plurality of character input keys 140 are arranged in the initial key input screen 100. These character input keys 140 are buttons for a user to input characters. In this embodiment, the character input keys 140 correspond to the alphabet and special symbols, and each key is formed so as to be associated with a character or a symbol represented thereon. In FIG. 4, a touch region 130, which indicates a position touched by a user, represents that a character input key (first button) 140N corresponding to the character “N” in the character input keys 140 has been touched for selection. The information input unit 20 obtains information regarding a position of the touch region 130 from the position coordinate detection unit 13, and sends the obtained information to the touch region determination unit 25.

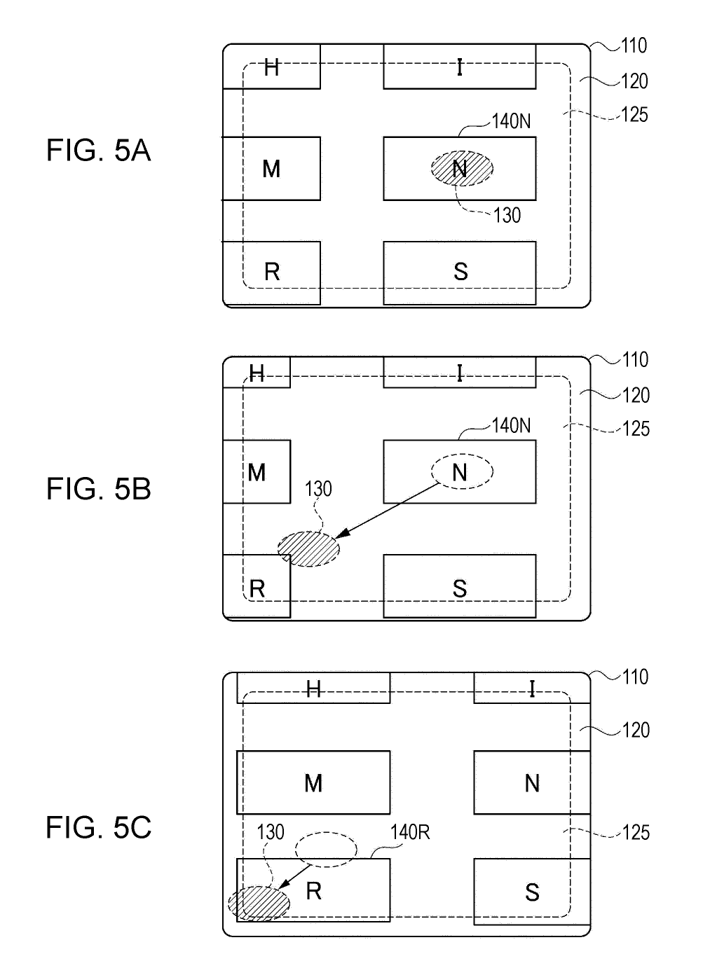

Referring to FIG. 1 again, the touch region determination unit 25 determines a region touched by a user, based on the information regarding the position of the touch region 130 sent from the information input unit 20. In this embodiment, the touch region determination unit 25 determines whether the touch region 130 of the user lies in a designation region 125 or a movement region 120 (FIG. 5A), and also determines a termination of the touch region (also, referred to as “a touch termination” for short) when the user moves his/her finger away from the touch panel. Here, the designation region 125 (first region) is a movable region for selecting character input keys 140 desired by the user. Also, the movement region 120 (second region) is a region for instructing a changing direction so as to change the character input keys 140 enlarged and displayed on the screen. In this embodiment, the initial key input screen 100 shows the entire designation region 125, but is not limited thereto.

The touch region determination unit 25 sends a driving instruction to either the input processing unit 30, the display direction decision unit 35 or the enlargement display determination unit 40, based on the determined result. In other words, the touch region determination unit 25 sends a driving instruction to the enlargement display determination unit 40 when the touch region 130 is determined to lie in the designation region. In addition, the touch region determination unit 25 sends a driving instruction to the display direction decision unit 35 when the touch region 130 is determined to lie in the movement region. Also, the touch region determination unit 25 sends a driving instruction to the input processing unit 30 when touch termination is determined.

The enlargement display determination unit 40 instructs the surrounding key enlargement display unit 50 to display an enlargement of the character input keys 140 when the screen displayed on the display unit 12 is the initial key input screen 100.

The surrounding key enlargement display unit 50 generates an enlargement image for the character input keys 140 based on an instruction for an enlargement of the display sent from the enlargement display determination unit 40 and the display direction decision unit 35, and displays the generated enlargement image on the display unit 12. In this case, an enlargement magnification at the time of generating the enlargement image may be set by a user in advance.

The enlargement region decision unit 52 decides a region of the character input keys 140 which will be displayed as an enlargement, according to an arrangement of the character input keys 140 in the initial key input screen 100. Here, when the instruction for an enlargement of the display is sent from the enlargement display determination unit 40, the enlargement region decision unit 52 decides an enlargement region, as shown in FIG. 5A, in order that the display is such that a central position of the touch region 130 in the initial key input screen 100 and a central position of the enlarged “N” character input key 140N approximately coincide with each other. Information regarding the enlargement region decided by the enlargement region decision unit 52 is sent to the enlargement image generation unit 54.

Based on the information regarding the enlargement region sent from the enlargement region decision unit 52, the enlargement image generation unit 54 generates an enlargement image for the character input keys 140, and displays the enlargement key input screen 110 containing the generated enlargement image on the display unit 12. As a result, the character input keys 140 in the enlargement key input screen 110 continues the same arrangement relation of the initial key input screen 100 and is displayed without rearrangement. Thereby, a user can easily moves to a desired character input key 140 without changing the touch position, in the state where the user is touching the same character input key 140 in the initial key input screen 100 and in the enlargement key input screen 110.

In this embodiment, the designation region 125 is formed in the central region of the enlargement key input screen 110, and the movement region 120 is formed with a belt shape along the periphery thereof. However, a form of the movement region 120, a position where it is formed, and its appearance are not limited to the aspect according to this embodiment, and, for example, the movement region may be formed at four corners of the enlargement key input screen 110. Also, the movement region 120 may become visible or not visible according to a position of the touch region 130, for example, it becomes visible when the touch region 130 approaches the movement region 120. In the case of being visible, the movement region may be translucent.

FIG. 5B shows a case where the position of the touch region 130 is moved from the state shown in FIG. 5A into the designation region 125. In this case, although the touch region 130 is moved, the enlargement image of the character input keys 140 in the enlargement key input screen 110 is not changed.

The display direction decision unit 35 decides a display direction of the character input keys 140 in the enlargement key input screen 110, in response to the driving instruction sent from the touch region determination unit 25. For example, as shown in FIG. 5C, when the touch region 130 is moved to the bottom left where the movement region 120 is positioned, the display direction decision unit 35 decides a display direction so that the character input keys 140 which are positioned in the bottom left portion are displayed in the central region of the enlargement key input screen 110 from the arrangement state of the character input key image generation mechanism 140 in FIG. 5A. In this case, the display direction may be a direction where the touch region 130 is moved from the center of the enlargement key input screen 110, or a direction determined by both a position of the touch region 130 in the designation region 125 and a position of the touch region 130 moved into the movement region 120. Also, the display direction may be decided by a position of the touch region 130 moved into the movement region 120. Information regarding the display direction decided by the display direction decision unit 35 is sent to the surrounding key enlargement display unit 50.

Here, the enlargement region decision unit 52 in the surrounding key enlargement display unit 50 decides an enlargement region based on the information regarding the display direction sent from the display direction decision unit 35. In this case, in order for the display direction to indicate the bottom left, the enlargement region is decided so that the character input key 140R corresponding to the character “R” is positioned in the central region of the enlargement key input screen 110. In addition, based on the information regarding the enlargement region sent from the enlargement region decision unit 52, the enlargement image generation unit 54 generates the enlargement image for the character input keys 140 which will be included in the enlargement region. The enlargement key input screen 110 including the generated enlargement image is displayed on the display unit 12 as shown in FIG. 5C.

When the touch region 130 lies in the movement region 120, the driving instruction sent from the touch region determination unit 25 to the display direction decision unit 35 may be sent continuously. In this case, the character input keys 140 displayed in the enlargement key input screen 110 are changed so as to be continuously moved to the top right. In addition, when the touch region 130 lies in the movement region 120, the driving instruction sent from the touch region determination unit 25 to the display direction decision unit 35 may be sent only once. In this case, the character input keys 140 displayed in the enlargement key input screen 110 are changed only once. Further, in this case, the character input keys 140 may be changed again by maintaining the touch region 130 in the movement region 120 for a further period of predetermined time.

The input processing unit 30 performs processing according to the touch termination by a user, depending on the driving instruction sent from the touch region determination unit 25. For example, in FIG. 5A, when a finger, which touched on the character input key 140N corresponding to the character “N,” is moved away from the display region of the touch panel input device 11, the input processing unit 30 determines that the key, which was touched by the finger immediately before the finger is in a no contact state with the display region, is selected. Thus, the input processing unit 30 determines that the character “N” is selected by the user, and sends a signal corresponding to the character “N” to the CPU 80. In addition, as shown in FIG. 5C, this is the same for the case where the touch region 130 indicates the movement region 120, and when the finger, which touched on the character input key 140R corresponding to the character “R,” is moved away from the display region of the touch panel input device 11, the input processing unit 30 determines that the character “R” is selected by the user, and sends a signal corresponding to the character “R” to the CPU 80.

In this embodiment, when a single character is selected by a user, the screen displayed on the display unit 12 does not change for a predetermined time. In this state, when the user touches the character input keys 140 with his/her finger again, and thereafter releases the finger therefrom (terminates the touch), the input processing unit 30 determines that a character corresponding to the character input key 140 which was touched by the user is subsequently selected, and performs the associated processing. On the other hand, when the character input keys 140 are not touched for a predetermined time, the input processing unit 30 may return the screen displayed on the display unit 12 to the initial key input screen 100.

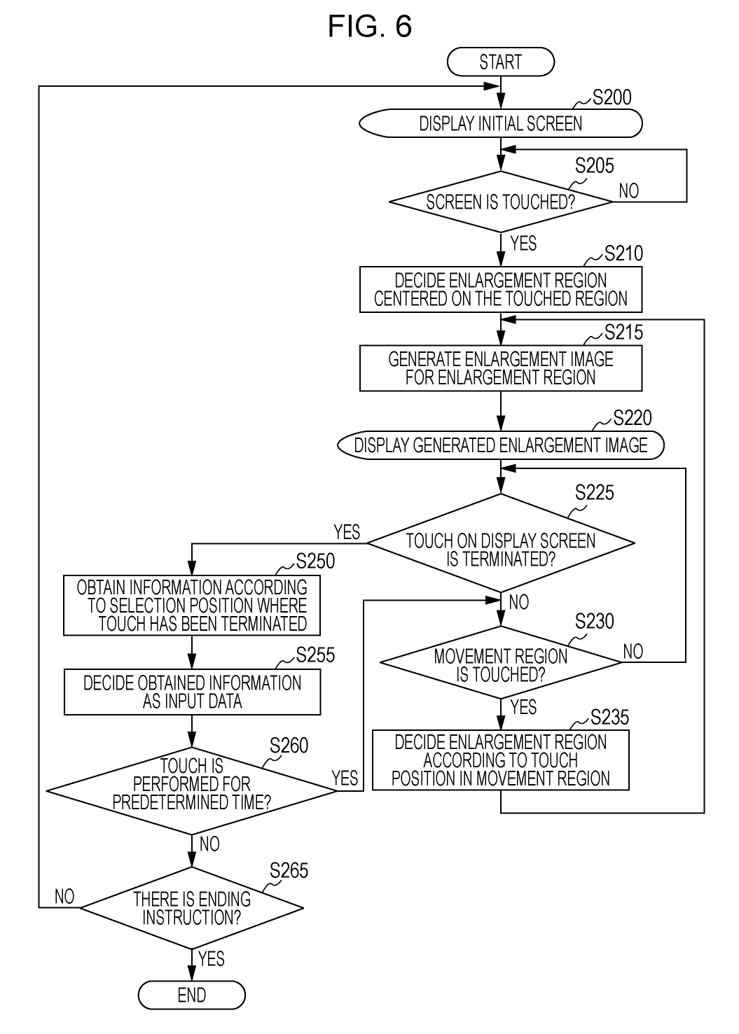

FIG. 6 is a flowchart illustrating a flow of information input processing in the information input device 5. When the information input device 5 initiates processing, the CPU 80 initially displays the initial key input screen 100, which is an initial screen, on the display region of the touch panel input device 11 (step S200).

Subsequently, the CPU 80 determines whether or not keys on the display screen have been touched by a user (step S205), and when none of the keys are touched (No at step S205), it repeats this step.

On the other hand, when it is determined that a key has been touched (Yes at step S205), the CPU 80 decides an enlargement region which is centered on the touched region (step S210).

The CPU 80 generates an enlargement image for the decided enlargement region (step S215), and displays the generated enlargement image on the display region of the touch panel input device 11, as the enlargement key input screen 110 (step S220) (first enlargement display step).

Thereafter, the CPU 80 determines whether or not a touch on the display screen has been terminated (step S225). When it is determined that the touch on the display screen has not been terminated at this step, that is, there is touching in progress (No at step S225), the CPU 80 determines whether or not the movement region 120 has been touched (step S230) (determination step).

At this step, when it is determined that the movement region 120 has not been touched but the designation region 125 has been touched (No at step S230), the flow returns to the step (step S225) where it is determined whether or not the screen touch has been terminated.

On the other hand, when it is determined that the movement region 120 has been touched (Yes at step S230), the CPU 80 decides an enlargement region according to a touched position in the movement region 120 (step S235) (decision step), and enters the step (step S215) where an enlargement image for an enlargement region is generated (second enlargement display step).

Further, at step S225, when it is determined that the touch on the display screen has been terminated (Yes at step S225), the CPU 80 obtains information regarding the character input key 140 according to the position where the touch has been terminated (step S250), and decides that the obtained information is input data (step S255) (input processing step).

Next, the CPU 80 determines whether or not a touch was performed within a predetermined time (step S260).

At this step, when the touch was performed by a user within the predetermined time (Yes at step S260), the flow returns to the step (step S230) where it is determined whether or not the movement region 120 has been touched.

On the other hand, when the touch has not been performed within the predetermined time (No at step S260), the CPU 80 checks whether or not there is an ending instruction (step S265). At this step, when there is the ending instruction (Yes at step S265), a chain of processing ends, and when there is no ending instruction (No at step S265), the flow returns to the step (step S200) where the initial screen is displayed.

According to the embodiment described above, a user touches desired character input keys 140 in the initial key input screen 100, and thereby the enlargement key input screen 110 is displayed where surrounding character input keys 140 including the touched character input key 140 are enlarged. In addition, the user touches the movement region 120 in the enlargement key input screen 110, whereby the character input keys 140 displayed according to the touch position of the movement region 120 are decided, and thus the enlargement key input screen 110 including the decided character input keys 140 is displayed. In this way, it is possible to enlarge and display the character input keys 140 arranged in a direction desired by a user, in the character input key 140 in the initial key input screen 100, and therefore the user can accurately input information via the touch panel input device 11.

What is claimed is:

1. An information input device, which displays button images showing a plurality of buttons on a display unit, detects an indication position by a position coordinate detection unit installed in the display unit, and thereby inputs information corresponding to the button which is indicated, comprising:
an enlargement display unit configured to generate a first enlargement image, which includes an indicated first button among the plurality of buttons, where the vicinity of the first button is enlarged as a display region, and to display the generated first enlargement image on the display unit;
a determination unit configured to determine whether an indication region which is indicated in the first enlargement image is included in a first region which is movable in the first enlargement image, or in a second region which instructs the changing of the display region;
a decision unit configured to decide a movement direction of the display region based on a position of the indication region included in the second region; and
an input processing unit configured to input information based on the button where an indication for the indication region has been terminated,
wherein the enlargement display unit generates a second enlargement image where the display region is moved in a movement direction decided by the decision unit, when the determination unit determines the indication region is included in the second region, and displays the generated second enlargement image on the display unit.

2. The information input device according to claim 1, wherein, the decision unit decides the movement direction based on either a direction from a central position of the first enlargement image to a position of the indication region, a direction from a position where the first button is indicated to a position of the indication region, or a direction predefined according to a position of the indication region.

3. The information input device according to claim 1, wherein, when the indication for the indication region is terminated, the enlargement display unit continues to display the first enlargement image or the second enlargement image displayed on the display unit so that an indication or an indication termination is possible, and when there is no indication or indication termination for a predetermined time, it displays the button images on the display unit.

4. The information input device according to claim 1, wherein, the enlargement display unit displays a region indicating the first button in the button images so that the region is constituted by the indication region indicating a central portion of the first button in the first enlargement image.

5. An information input method, which displays button images showing a plurality of buttons on a display unit, detects an indication position by a position coordinate detection unit installed in the display unit, and thereby inputs information corresponding to the button which is indicated, comprising:
generating a first enlargement image, which includes an indicated first button in the plurality of buttons, where the vicinity of the first button is enlarged as a display region, and to display the generated first enlargement image on the display unit;
determining whether an indication region which is indicated in the first enlargement image is included in a first region which is movable in the first enlargement image, or in a second region which instructs the changing of the display region;
deciding a movement direction of the display region based on a position of the indication region included in the second region;
generating a second enlargement image where the display region is moved in a movement direction decided at the deciding step, when it is determined that the indication region is included in the second region at the determining step, and displaying the generated second enlargement image on the display unit; and
inputting information based on the button where an indication for the indication region has been terminated.
